(19) United States
(12) Patent Application Publication
(10) Pub. No.: US 2004/0227849 A1
(43) Pub. Date: Nov. 18, 2004

(54) Digital camera module with compact lens holder and mobile phone incorporating same

(76) Inventor: Tsung Wei Chiang, Tu-chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/812,644

(22) Filed: Mar. 29, 2004

(30) Foreign Application Priority Data
Mar. 28, 2003 (TW) 92204912

(51) Int. Cl. H04N 5/225

(52) U.S. Cl. 348/374

(57) ABSTRACT

A digital camera module for a mobile phone has a lens holder (10) and a printed circuit board (20). The lens holder includes a base (12) and a cylinder (11) extending from the base. The base has a bottom portion engaging with the printed circuit board. The bottom portion includes a first sidewall (121), a third sidewall (123) opposite to the first sidewall, and a second sidewall (122) interconnecting the first and third sidewalls. Each of the first and the third sidewalls has a holder (1211) for holding the printed circuit board. The second sidewall has a flat surface for supporting the printed circuit board, and a projection (1222) extending from the flat surface and received in the printed circuit board.

### BACKGROUND OF THE INVENTION

1. Field of the Invention

This invention relates in general to digital cameras, and more specifically to a digital camera module for use in a portable electronic device.

2. Prior Art

Portable electronic devices, such as mobile phones, are extremely popular these days. Recently, digital camera modules have been added to mobile phones to provide a second function. A digital camera module has a lens, a lens holder, and a printed circuit board. Referring to FIG. 4, a camera module as disclosed in China Pat. No. 01235658.1 includes a lens holder 2 and a printed circuit board 4. The printed circuit board 4 is soldered to the lens holder 2, generally at a temperature no less than 240° C. However, the lens holder 2 is typically made of polycarbonate, and is liable to deform at such high temperatures. If the lens holder 2 sustains deformation, this may impair assembly and performance of the digital camera module.

To reduce the likelihood of such deformation e, many other kinds of plastics may be used instead of polycarbonate. However, these plastics are more costly. In addition, the printed circuit board 4 is joined to an outside of the lens holder 2, which increases an overall height of the camera module. This militates against the modern trend toward miniaturization of electronic devices.

Furthermore, assembly of the above-described camera module requires an unduly large number of steps.

A need therefore exists for a low-cost, low-profile camera module that is easily assembled.

### SUMMARY OF THE INVENTION

Accordingly, in one aspect of the present invention, a digital camera module for a portable telephone is provided. The digital camera module comprises a lens holder and a printed circuit board. The lens holder comprises a base, and a cylinder extending from the base for receiving a lens. The base has a bottom portion engaged with the printed circuit board. The bottom portion comprises a first sidewall, an opposite third sidewall, and a second sidewall interconnecting the first and third sidewalls. Each of the first and the third sidewalls has a holder element for holding the printed circuit board. The second sidewall has a flat surface for supporting the printed circuit board, and a projection extending from the flat surface and received in the printed circuit board.

In another aspect of the present invention, a portable telephone includes an information transceiver module and a camera module. The camera module comprises a base, a cylinder extending from the base for receiving a lens, and a printed circuit board engaged with a bottom portion of the base. The bottom portion comprises a first sidewall, a third sidewall opposite to the first sidewall, and a second sidewall interconnecting the first and third sidewalls. Each of the first and the second sidewalls has a holder means for holding the printed circuit board. The second sidewall has a flat surface for supporting the printed circuit board, and a projection extending from the flat surface and received in the printed circuit board.

Other objects, advantages and novel features of the present invention will become more apparent from the following detailed description when taken in conjunction with the accompanying drawings, in which:

### BRIEF DESCRIPTION OF THE DRAWINGS

FIG. 1 is an isometric view of a camera module according to the present invention;

FIG. 2 is an exploded, isometric view of the camera module of FIG. 1, viewed from another aspect;

FIG. 3 is an assembled view of FIG. 2; and

FIG. 4 is an exploded, isometric view of a conventional camera module.

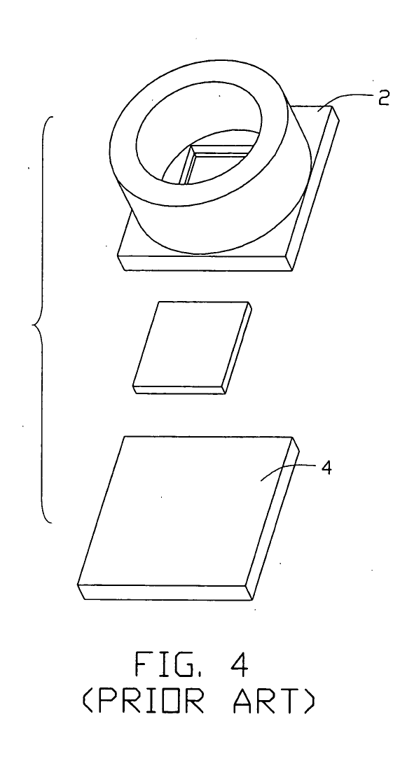

### DETAILED DESCRIPTION OF THE INVENTION

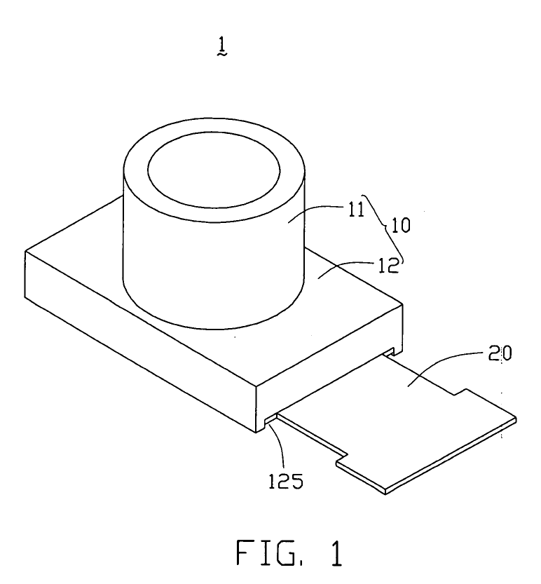

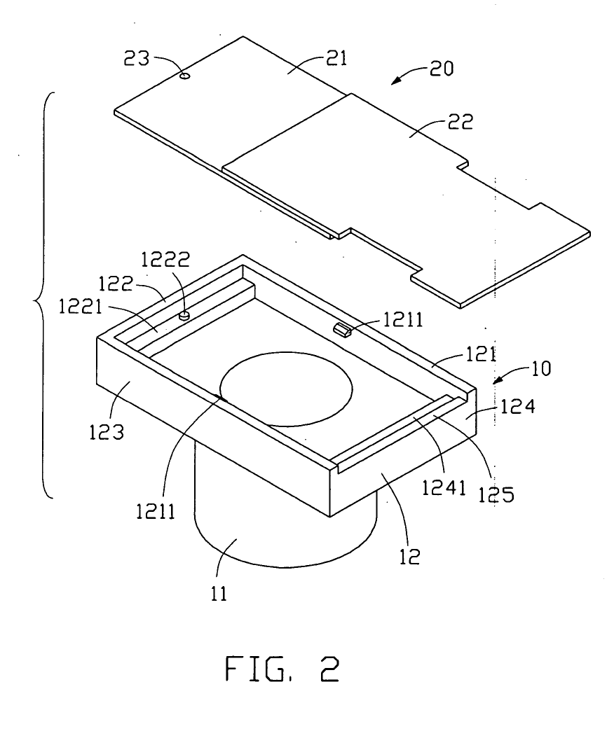

Referring to FIGS. 1 and 2, a digital camera module 1 according to the present invention comprises a lens holder 10 and a printed circuit board 20. The lens holder 10 comprises a base 12, and a cylinder 11 extending from a top of the base 12. The cylinder 11 is hollow, for receiving a plurality of camera lenses (not shown). The base 12 is generally rectangular, but can alternatively be configured to be another desired shape such as oval or round. The base 12 has a bottom portion for holding the printed circuit board 20. The bottom portion comprises a first sidewall 121, a second sidewall 122, a third sidewall 123, and a fourth sidewall 124. The first sidewall 121 and the third sidewall 123 are opposite each other, and each has a holder 1211. In the preferred embodiment, each holder 1211 is a projection extending from an inner surface of the respective first sidewall 121 and third sidewall 123.

The second sidewall 122 interconnects the first sidewall 121 and the third sidewall 123. The fourth sidewall 124 is opposite to the second sidewall 122, and also interconnects the first sidewall 121 with the third sidewall 123. A first support 1221 extends from an inner side of the second sidewall 122, for supporting one end of the printed circuit board 20. A second support 1241 extends from an inner side of the fourth sidewall 124, for supporting an opposite end of the printed circuit board 20. The first and second supports 1221, 1241 are disposed higher than a bottom of the base 12. In the preferred embodiment, a vertical distance from bottom surfaces of the first and second supports 1221, 1241 to top surfaces of the holders 1211 is not less than a thickness of the printed circuit board 20. A bottom surface of the first support 1221 is flat, and at least one projection 1222 is formed thereon for positioning the printed circuit board 20. The projection 1222 does not extend beyond a bottom of the second sidewall 122. The fourth sidewall 124 does not extend as far down as the first, second and third sidewalls 121, 122, 123. Thus the four sidewalls 121, 122, 123, 124 cooperatively define a slot 125 for receiving the printed circuit board 20. When the printed circuit board 20 is received in the slot 125, it is positioned no lower than the bottom of the base 12.

The printed circuit board 20 comprises a first board 21 and a second board 22, the second board 22 partly overlapping the first board 21 to assure good electrical connection therebetween. The first board 21 defines a hole 23 therethrough, for receiving the projection 1222 of the first support 1221 therein.

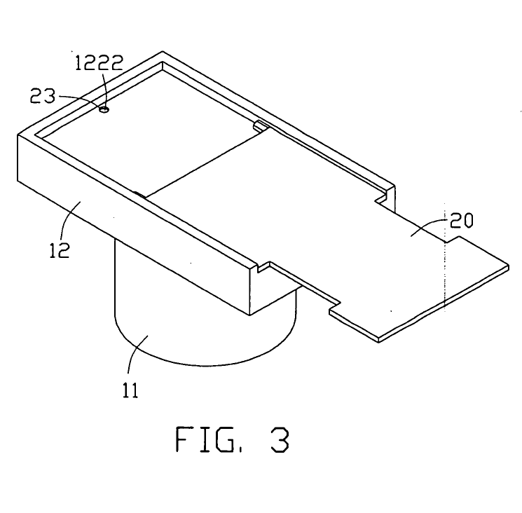

Referring also to FIG. 3, in assembly, the printed circuit board 20 is slid into the base 12 until the hole 23 of the first board 21 engagingly receives the projection 1222. In this position, the first board 21 of the printed circuit board 20 is cooperatively supported and held by the first support 1221 and the holders 1211. The second board 22 is received in the slot 125, and is blocked from being over-inserted into the base 12 by the holders 1211.

In the digital camera module 1 according to the present invention, the printed circuit board 20 is held in place by the holders 1211 and first support 1221. No soldering is required, unlike conventional lens holders. The printed circuit board 20 is not exposed to high soldering temperatures, and the cost of the base 2 is reduced. In addition, the printed circuit board 20 is held in the slot 125, and does not project beyond the bottom of the base 12. A height of the digital camera module 1 can thus be reduced. An associated portable electronic device can accordingly be made thinner and smaller.

In particular, the digital camera module 1 according to the invention can be incorporated in a mobile phone (not shown). The mobile phone comprises an information transceiver module and the digital camera module 1. The mobile phone then provides not only the function of a voice/digital communicator, but also the function of a camera. With the small digital camera module 1, the mobile phone can be made correspondingly compact.

It is to be noted that the detailed description provided above should be viewed as being exemplary of the invention, and not as being restrictive of the invention as claimed herebelow.

What is claimed is:

1. A digital camera module for use in a portable electronic device, comprising:
a lens holder, including a base and a tube element for receiving a lens; and
a printed circuit board;
wherein the tube element extends from a top of the base, the base comprises a bottom portion engaging with the printed circuit board, the bottom portion comprises a first sidewall and a third sidewall opposite to the first sidewall, and at least one of the first and the third sidewalls has a holder means for holding the printed circuit board.

2. The digital camera module as set forth in claim 1, wherein the bottom portion further comprises a second sidewall interconnecting the first and the third sidewalls.

3. The digital camera module as set forth in claim 1, wherein the tube element is cylindrical.

4. The digital camera module as set forth in claim 2, wherein a support means for supporting the printed circuit board extends from an inside of the second sidewall.

5. The digital camera module as set forth in claim 4, wherein the support means is between the first and third sidewalls.

6. The digital camera module as set forth in claim 4, wherein the support means has a flat surface.

7. The digital camera module as set forth in claim 4, wherein the support means has a projection received in the printed circuit board.

8. A mobile phone, comprising:
an information transceiver module; and
a camera module;
wherein the camera module comprises a base, a cylinder extending from the base for receiving a lens, and a printed circuit board, the base comprises a bottom portion engaging with the printed circuit board, the bottom portion comprises a first sidewall and a third sidewall opposite to the first sidewall, and each of the first and the third sidewalls has a holder means for holding the printed circuit board.

9. The mobile phone as set forth in claim 8, wherein the bottom portion further comprises a second sidewall interconnecting the first and third sidewalls.

10. The mobile phone as set forth in claim 9, wherein a support means for supporting the printed circuit board extends from an inside of the second sidewall.

11. The mobile phone as set forth in claim 10, wherein the support means is between the first and the third sidewalls, and has a flat bottom.

12. The mobile phone as set forth in claim 9, wherein the support means has a projection received in the printed circuit board.

13. A digital camera module for use within an electronic device, comprising:
a lens holder defining a chamber-like base with a tube element extending from a top portion thereof;
a lens essentially located in said tube element;
a printed circuit board essentially located around a bottom portion of the base opposite to said tubular element;
means for detachably retaining said printed circuit board in the base horizontally; and
means for detachably retaining said printed circuit board in the base vertically.
